(19) United States
(12) Patent Application Publication
(10) Pub. No.: US 2013/0249759 A1
(43) Pub. Date: Sep. 26, 2013

(54) ANTENNA, DIPOLE ANTENNA, AND COMMUNICATION APPARATUS USING THE SAME

(71) Applicants: Djuniadi Arifin Sagala, Soraku-gun (JP); Kentaro Miyazato, Krishima-shi (JP)

(72) Inventors: Djuniadi Arifin Sagala, Soraku-gun (JP); Kentaro Miyazato, Krishima-shi (JP)

(73) Assignee: Kyocera Corporation, Kyoto-shi, Kyoto (JP)

(21) Appl. No.: 13/989,636

(22) PCT Filed: Nov. 28, 2011
(86) PCT No.: PCT/JP2011/077369

§ 371 Date: May 24, 2013

(30) Foreign Application Priority Data
Nov. 26, 2010 (JP) 2010-263832
May 30, 2011 (JP) 2011-120657

(51) Int. Cl. H01Q 9/06

(52) U.S. Cl. CPC H01Q 9/065; H01Q 9/06
USPC 343/806; 343/700 MS; 343/793

(57) ABSTRACT

A compact antenna and a communication apparatus using the same are provided. An antenna includes a strip-shaped conductor in which a plurality of strip-shaped m-th order elements, where m is an integer of 3 or more, are sequentially connected to one another. Herein n-th order elements constituting the strip-shaped conductor, where n is all integers equal to or more than 2 and equal to or less than m, are configured to be p n-th order elements into which an (n−1)-th order element is divided, where p is an integer of 3 or more, and the n-th order elements divided into p have bent shapes at respective boundary parts between the n-th order elements and are located so that a vector direction from one end of the (n−1)-th order element to the other end thereof does not vary. A compact high-performance antenna is obtained.

### TECHNICAL FIELD

The present invention relates to an antenna having a strip-shaped conductor, a dipole antenna having the antenna, and a communication apparatus using the same.

### BACKGROUND ART

As one of antennas which perform transmitting and receiving of electromagnetic waves in a communication apparatus, a dipole antenna or a monopole antenna is known, for example, as disclosed in Japanese Unexamined Patent Publication JP-A 5-259728 (1993).

### SUMMARY OF INVENTION

The dipole antenna is basically required to have a conductor having a length of ½ wavelength, and the monopole antenna is basically required to have a conductor having a length of ¼ wavelength and a ground surface. Therefore, there is a problem that shapes thereof are large-sized.

The invention has been made in light of the problem in the related art, and an object thereof is to provide an antenna which can be miniaturized and has a strip-shaped conductor, a dipole antenna having the antenna, and a communication apparatus using the same.

An antenna of the invention comprises a strip-shaped conductor in which a plurality of strip-shaped m-th order elements, where m is an integer of 3 or more, are sequentially connected to one another, wherein n-th order elements constituting the strip-shaped conductor, where n is all integers equal to or more than 2 and equal to or less than m, are configured to be p n-th order elements into which an (n−1)-th order element is divided, where p is an integer of 3 or more, and the n-th order elements divided into p have bent shapes at respective boundary parts between the n-th order elements and are located along a straight line parallel to a line segment connecting one end of the (n−1)-th order element to the other end thereof.

A dipole antenna of the invention comprises a first antenna and a second antenna which are the antenna mentioned above, wherein a shape of the conductor of the first antenna and a shape of the conductor of the second antenna are the same, each of first order elements of the strip-shaped conductors being linear, and line segments connecting both ends of each of the strip-shaped conductors are located on a same straight line.

A dipole antenna of the invention comprises a first antenna and a second antenna which are the antenna mentioned above, wherein a shape of the strip-shaped conductor of the first antenna and a shape of the strip-shaped conductor of the second antenna are line-symmetric, each of first order elements of the strip-shaped conductors being linear, and line segments connecting both ends of each of the strip-shaped conductors are located on a same straight line.

A communication apparatus of the invention comprises the antenna mentioned above, and at least one of a receiving circuit and a transmitting circuit which are connected to the antenna.

A communication apparatus of the invention comprises the dipole antenna mentioned above, and at least one of a receiving circuit and a transmitting circuit which are connected to the dipole antenna.

In addition, an angle between the n-th order elements adjacent to each other means an angel which is made between a line segment connecting both ends of one adjacent n-th order element and a line segment connecting both ends of the other adjacent n-th order element, and is smaller than 180°.

According to the invention, it is possible to obtain an antenna and a dipole antenna which can be miniaturized. In addition, it is possible to obtain a communication apparatus which has the antennas and can be miniaturized.

### BRIEF DESCRIPTION OF DRAWINGS

FIG. 1 is a perspective view schematically illustrating an antenna (dipole antenna) according to an embodiment of the invention;

FIG. 2 is a schematic top view of the antenna (dipole antenna) shown in FIG. 1;

FIG. 3 is a schematic plan view illustrating a shape of a conductor 20 in the antenna shown in FIGS. 1 and 2;

FIG. 4 is a top view schematically illustrating an antenna according to an embodiment of the invention;

FIG. 5 is a top view schematically illustrating an antenna according to an embodiment of the invention;

FIG. 6 is a top view schematically illustrating an antenna according to an embodiment of the invention;

FIG. 7 is an enlarged view illustrating a shape of a conductor 320 of a region A of the antenna shown in FIG. 6;

FIG. 8 is a schematic plan view illustrating a modified example of a shape of a conductor in the antenna of the invention;

FIG. 9 is a schematic plan view illustrating a modified example of a shape of a conductor in the antenna of the invention;

FIG. 10 is a top view schematically illustrating a modified example of the dipole antenna of the invention;

FIG. 11 is a perspective view schematically illustrating a modified example of the antenna (dipole antenna) of the invention;

FIG. 12 is a block diagram schematically illustrating an example of a communication apparatus according to an embodiment of the invention;

FIG. 13 is a schematic diagram illustrating a coordinate system in a simulation;

FIG. 14 is a graph illustrating a radiation pattern of a directional gain on an xy plane;

FIG. 15 is a graph illustrating a radiation pattern of a directional gain on a zx plane;

FIG. 16 is a graph illustrating a radiation pattern of a directional gain on a zy plane; and

FIG. 17 is a graph illustrating a radiation pattern of a directional gain on the zy plane.

### DESCRIPTION OF EMBODIMENTS

Hereinafter, an antenna, a dipole antenna, and a communication apparatus using the same of the invention will be described in detail with reference to the accompanying drawings. In addition, in the present specification, a conductor having a bent shape is described using expression of folding the conductor; however, this expression is used for convenience in order to describe a shape of a pattern, and there may no process of practically folding the conductor in manufacturing an antenna.

### First Embodiment

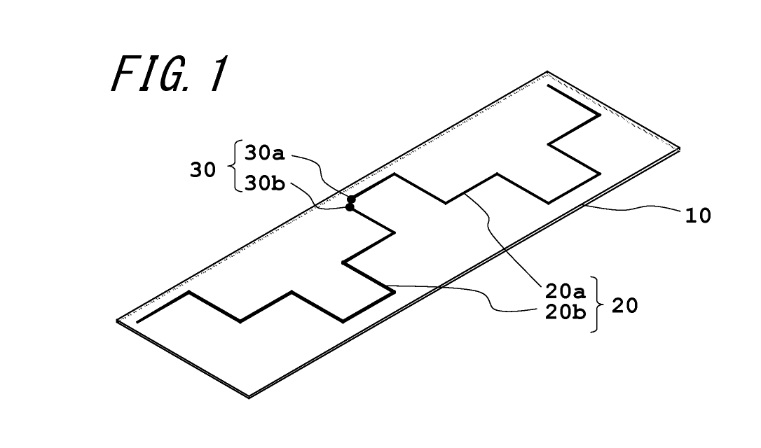

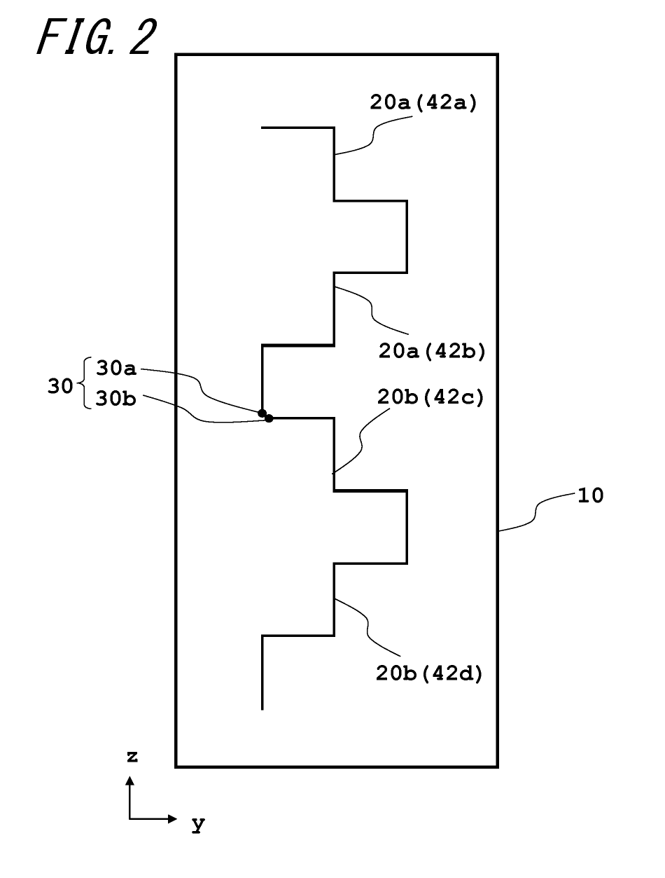

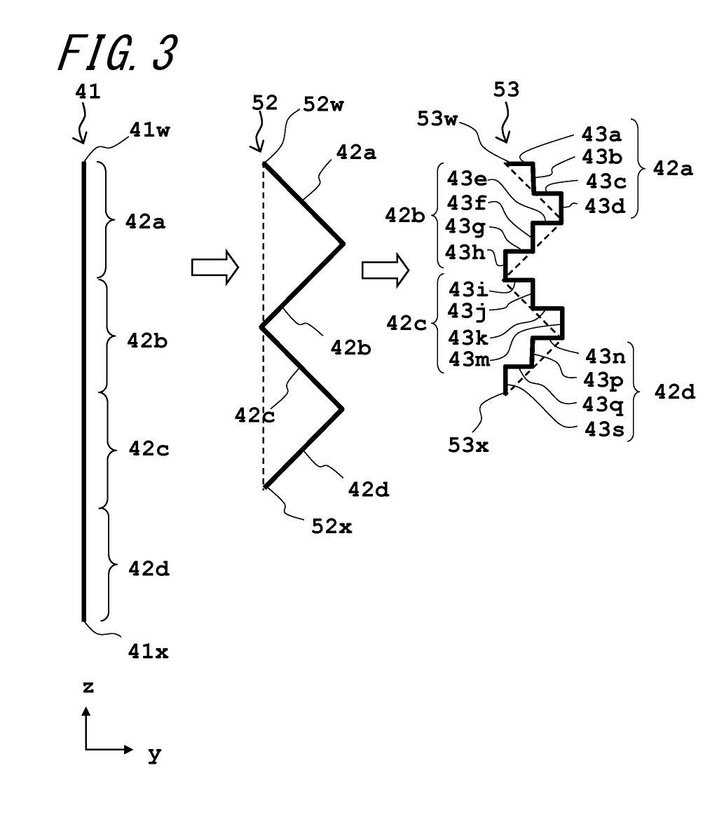

FIG. 1 is a perspective view schematically illustrating an antenna according to a first embodiment of the invention. FIG. 2 is a schematic top view of the antenna shown in FIG. 1. FIG. 3 is a schematic plan view illustrating a shape of the conductor 20 in the antenna in this embodiment shown in FIGS. 1 and 2.

The antenna of this embodiment, as shown in FIGS. 1 and 2, includes a dielectric substrate 10, and a strip-shaped conductor 20 having a predetermined shape, disposed on the upper surface of the dielectric substrate. In addition, the strip-shaped conductor 20 is divided into a conductor 20a and a conductor 20b at the center, and a terminal portion 30 includes terminals 30a and 30b provided at divided locations. The conductor 20 is supplied with power at the terminal portion 30, and functions as a dipole antenna which has the conductors 20a and 20b as elements.

In addition, in the following description, the conductor 20 will be described assuming that the conductor 20a and the conductor 20b are not divided but are connected to each other.

The left part of FIG. 3 shows a first order element 41, the central part thereof shows second order elements 42a to 42d, and the right part thereof shows third order elements 43a to 43s. FIG. 3 shows a design method of a pattern of the conductor 20 through schematic decomposition.

First, the first order element 41 is divided into four second order elements 42a to 42d. In addition, each of the four second order elements is divided into four third order elements, and thus there are a total of sixteen third order elements 43a to 43s. As a result, the conductor 20 in the antenna of this embodiment has a structure formed by sequentially connecting the sixteen strip-shaped third order elements 43a to 43s.

The linear first order element 41 is divided into the four second order elements 42a to 42d. In addition, respective boundary parts of the second order elements 42a to 42d have a folded shape along a straight line (indicated by the dotted line; 52w to 52x) parallel to a line segment which connects one end 41w of the first order element 41 to the other end 41x thereof. In other words, the boundary parts of the respective second order elements 42a to 42d are folded and have a bent shape such that a vector direction from one end of the first order element 41 to the other end thereof does not vary.

In addition, each of the second order elements 42a to 42d is divided into four third order elements. At this time, respective boundary parts of the third order elements 43a to 43d have a folded shape along a straight line (indicated by the dotted line) parallel to a line segment which connects one end of the second order element 42a to the other end thereof. This is also the same for the other three second order elements 42b to 42d. In other words, the boundary parts of the respective third order elements 43a to 43s are folded and have a bent shape such that a vector direction from one end of each of the second order elements 42a to 42d to the other end thereof does not vary.

In addition, in this embodiment, the first order element 41 is linear, the first order element 41 is divided into the four second order elements 42a to 42d having the same length and has a shape in which the boundary parts of the respective second order elements 42a to 42d in the first order element 41 are sequentially bent in a reverse direction such that an angle between the second order elements 42a to 42d adjacent to each other is 90°.

In addition, each of the second order elements 42a to 42d is divided into the four third order elements having the same length, and has a shape in which the boundary parts of the respective third order elements in each of the second order elements 42a to 42d are sequentially bent in a reverse direction such that an angle between the third order elements adjacent to each other is 90°.

Here, the length of the first order element 41, the length of the second order shape 52 in which the four second order elements are connected to each other, and the length of the third order shape 53 in which the sixteen third order elements are connected to each other, are all the same. Here, when the sizes in a z direction of FIG. 3 are compared, the second order shape 52 is 2½ times the size of the first order element 41, and since the third order shape 53 is 2½ times the size of the second order shape 52, the third order shape 53 is ½ of the first order element 41. In other words, according to the antenna of this embodiment, it is possible to obtain a miniaturized antenna whose length in the longitudinal direction (z direction in the figure) is reduced to ½ as compared with a basic antenna having a linear conductor such as the first order element 41.

In a design of this antenna, the following procedures may be performed such that a length in the longitudinal direction (z direction in the figure) is a desired length.

(Procedure 1) A linear first order element is divided into four second order elements having the same length, and boundary parts of the second order elements are sequentially folded in a reverse direction such that an angle formed between the second order elements adjacent to each other is 90°. At this time, a straight line connecting both ends of the first order element before being folded is made to be parallel to a straight line connecting both ends of the first order element after being folded.

(Procedure 2) Each of the second order elements is divided into four third order elements having the same length, and boundary parts of the third order elements are folded such that an angle formed between the third order elements adjacent to each other is 90°. At this time, the third order elements are sequentially folded in a reverse direction in each second order element, and a straight line connecting both ends of each second order element before being folded is made to be parallel to a straight line connecting both ends of each second order element after being folded.

(Procedure 3) The order of elements increases by one as necessary, and an operation of the previous procedure is performed.

(Procedure 4) The operation of the procedure 3 is repeatedly performed until the order of elements arrives at a desired order as necessary.

When generally expressed, the antenna of this embodiment includes the conductor 20 in which a plurality of strip-shaped m-th order elements (where m is an integer of 3 or more) are sequentially connected, and, n-th order elements constituting the conductor 20 (where n is all integers equal to or more than 2 and equal to or less than m), are configured to be p n-th order elements into which an (n−1)-th order element is divided (where p is an integer of 3 or more). In addition, the n-th order elements divided into p have bent shapes at respective boundary parts between the n-th order elements and are located along a straight line parallel to a line segment connecting one end of the (n−1)-th order element to the other end thereof. In other words, the respective boundary parts of the n-th order elements have folded shapes such that a vector direction from one end of the (n−1)-th order element to the other end thereof does not vary. At this time, a straight line connecting both ends of the (n−1)-th order element before being folded is parallel to a straight line connecting both ends of the p n-th order elements after being folded into which the (n−1)-th order element is divided. In addition, in the embodiment shown in FIGS. 1 to 3, the maximum order m is 3, and the division number p is 4.

In the antenna of this embodiment having the configuration, since the boundary parts of the n-th order elements are folded such that a vector direction from one end of the (n−1)-th order element to the other end thereof does not vary, a vector sum of a current flowing through the respective m-th order elements is approximately the same as a vector from one end 53w of the conductor 20 to the other end 53x thereof. In other words, a direction of the vector sum of the current flowing through the respective m-th order elements is approximately the same as a direction when a current flowing through the conductor 20 formed only by the original first order element 41 is represented by a vector. Therefore, according to the antenna of this embodiment, it is possible to obtain a miniaturized antenna which maintains approximately the same antenna characteristics also including directivity as compared with a linear antenna having the conductor 20 which is formed only by the original first order element 41. Therefore, an antenna which is miniaturized, has a high performance, and is easily designed is obtained.

In addition, it is preferable to satisfy a condition in which the divided p n-th order elements have the same length, and angles formed by the n-th order elements adjacent to each other in each of the (n−1)-th order elements are all the same. With this configuration, symmetry of an antenna increases, and thus an antenna having desired characteristics is easily designed.

In addition, a bent shape is preferable in which an angle between the n-th order elements adjacent to each other is θ (90°≦θ<180°). With this configuration, there is no reverse component in current vectors of the n-th order elements adjacent to each other, and overlapping between the n-th order elements can be simply prevented. Therefore, it is possible to obtain an antenna which has a higher performance and is easily designed.

Next, an embodiment of the dipole antenna of the invention exemplified in FIGS. 1 to 3 will be described. The dipole antenna of this embodiment has two antennas including a first antenna (the conductor 20a) and a second antenna (the conductor 20b) having the same shape. The antennas are antennas having the above-described configuration of the invention. In addition, a line segment connecting both ends of the first antenna (the conductor 20a) and a line segment connecting both ends of the second antenna (the conductor 20b) are located on the same straight line.

This is exactly a state in which the antenna according to an embodiment of the invention, designed to maintain characteristics and to be reduced such as the first order element 41->the second order shape 52->the third order shape 53 in FIG. 3, is equally divided into two at the center in the longitudinal direction, and forms a dipole antenna by being supplied with power at the division parts. Therefore, according to the dipole antenna of this embodiment, it is possible to easily obtain, without using an electromagnetic simulation, a dipole antenna which maintains approximately the same characteristics also including directivity and is further miniaturized, without using an electromagnetic field simulation, as compared with a dipole antenna which is divided at the center of the linear first order element 41 and has power supply points at the division parts.

In the antenna of this embodiment, the dielectric constant of the dielectric substrate 10 is, for example, about 2 to 20. A material of the dielectric substrate 10 is not particularly limited, and may use a resin such as glass epoxy. In addition, dielectric ceramics are preferably used from the viewpoint of accuracy when the dielectric substrate 10 is formed and easiness of manufacturing. The conductor 20 is made of metal having good conductivity such as, for example, gold, silver, copper, and an alloy thereof, and, a thickness thereof is, for example, about 3 μm to 50 μm. The conductor may be formed using either a thick film method such as printing or a thin film method such as a PVD method or a CVD method.

### Second Embodiment

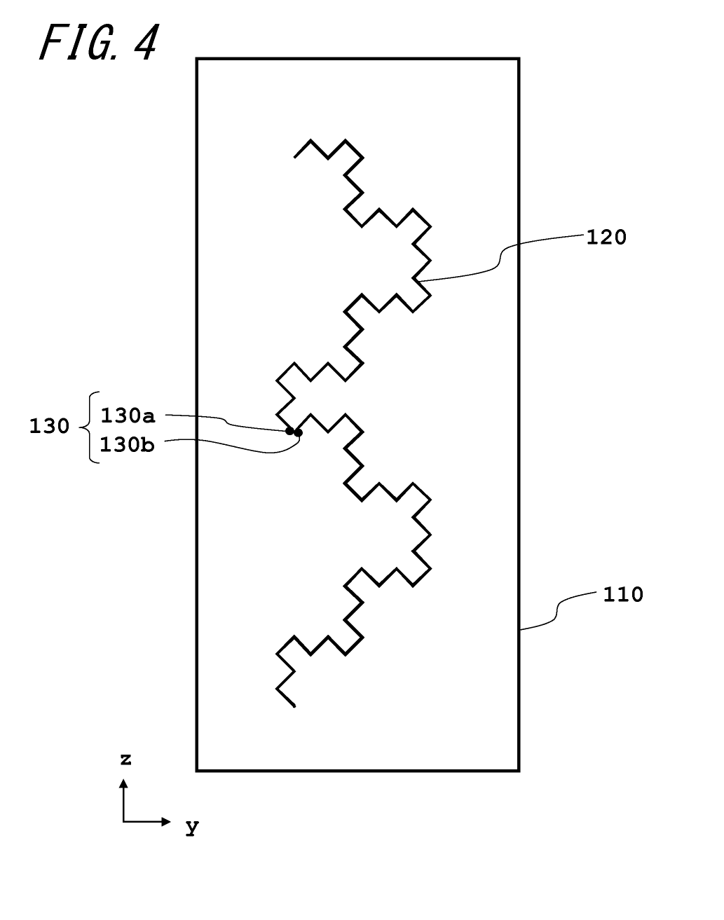

FIG. 4 is a top view schematically illustrating an antenna according to a second embodiment of the invention. In addition, in this embodiment, a difference from the above-described first embodiment will be described, and repeated description of the same element will be omitted. When this embodiment is generally expressed, the maximum order m is 4, and the division number p is 4.

As shown in FIG. 4, a conductor 120 of the antenna of this embodiment is provided on a dielectric substrate 110 and is formed by sequentially connecting 64 fourth order elements having a strip-shape. The fourth order elements have a shape in which each of the third order elements 43a to 43s having the third order shape 53 shown in FIG. 3 is divided into four fourth order elements having the same length, and boundary parts of the fourth order elements in each of the third order elements 43a to 43s are sequentially bent in a reverse direction such that a vector direction from one end of each of the third order elements 43a to 43s to the other end thereof does not vary and an angle between the fourth order elements adjacent to each other is 90°.

According to the antenna of this embodiment, it is possible to obtain a miniaturized antenna which maintains approximately the same antenna characteristics also including directivity and has a length in the longitudinal direction (z direction in the figure) reduced to a length multiplied by 2 3/2 as compared with a basic antenna having a linear conductor such as the first order element 41 of FIG. 3.

In addition, as shown in FIG. 4, the conductor 120 of the antenna may be equally divided into two at the center in the longitudinal direction, and may function as a dipole antenna by providing power supply points 130a and 130b at the division part 130. A line segment connecting both ends of a first antenna (on which the power supply point 130a is located) and a line segment connecting both ends of a second antenna (on which the power supply point 130b is located) are located on the same straight line, which thus can be regarded as an embodiment of the dipole antenna of the invention.

### Third Embodiment

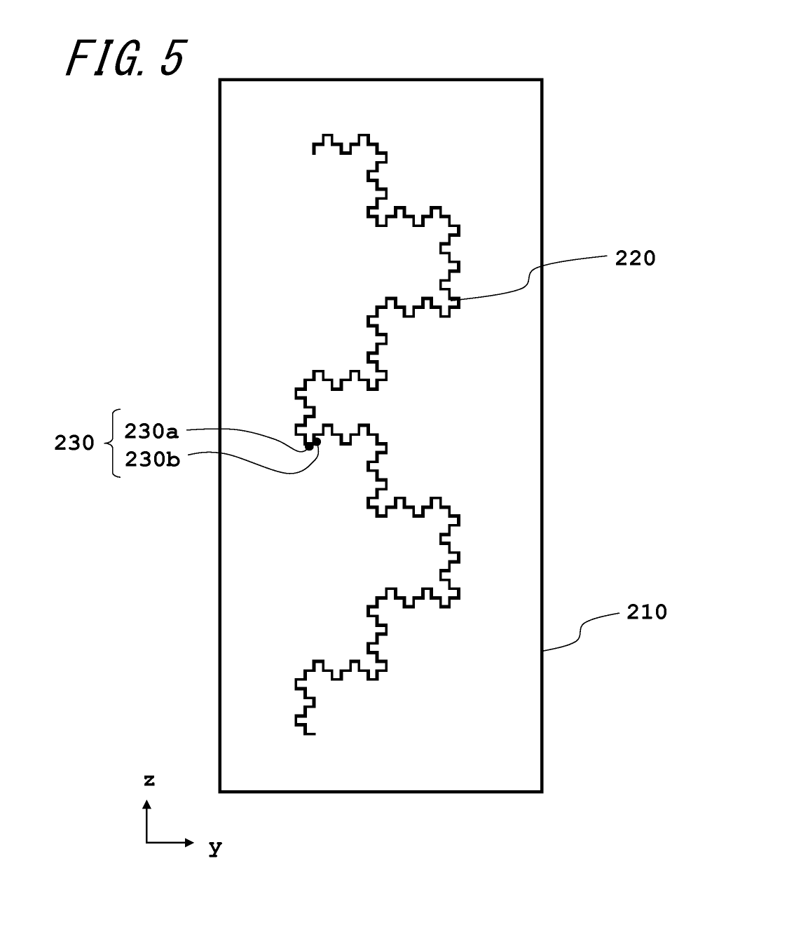

FIG. 5 is a top view schematically illustrating an antenna according to a third embodiment of the invention. In addition, in this embodiment, a difference from the above-described embodiments will be described, and repeated description of the same element will be omitted. When this embodiment is generally expressed, the maximum order m is 5, and the division number p is 4.

As shown in FIG. 5, a conductor 220 of the antenna of this embodiment is provided on a dielectric substrate 210 and is formed by sequentially connecting 256 fifth order elements having a strip-shape. The fifth order elements have a shape in which each of the fourth order elements of the conductor 120 of the antenna shown in FIG. 4 is divided into four fifth order elements having the same length, and boundary parts of the fifth order elements in each of the fourth order elements are sequentially bent in a reverse direction such that a vector direction from one end of each of the fourth order elements to the other end thereof does not vary and an angle between the fifth order elements adjacent to each other is 90°.

According to the antenna of this embodiment, it is possible to obtain a miniaturized antenna which maintains approximately the same antenna characteristics including directivity and has a length in the longitudinal direction (z direction in the figure) reduced to a length multiplied by ¼ as compared with a basic antenna having a linear conductor such as the first order element 41 of FIG. 3.

In addition, as shown in FIG. 5, the conductor 220 of the antenna may be equally divided into two at the center in the longitudinal direction, and may function as a dipole antenna by providing power supply points 230a and 230b at the division part 230. A line segment connecting both ends of a first antenna (on which the power supply point 230a is located) and a line segment connecting both ends of a second antenna (on which the power supply point 230b is located) are located on the same straight line, which thus can be regarded as an embodiment of the dipole antenna of the invention.

### Fourth Embodiment

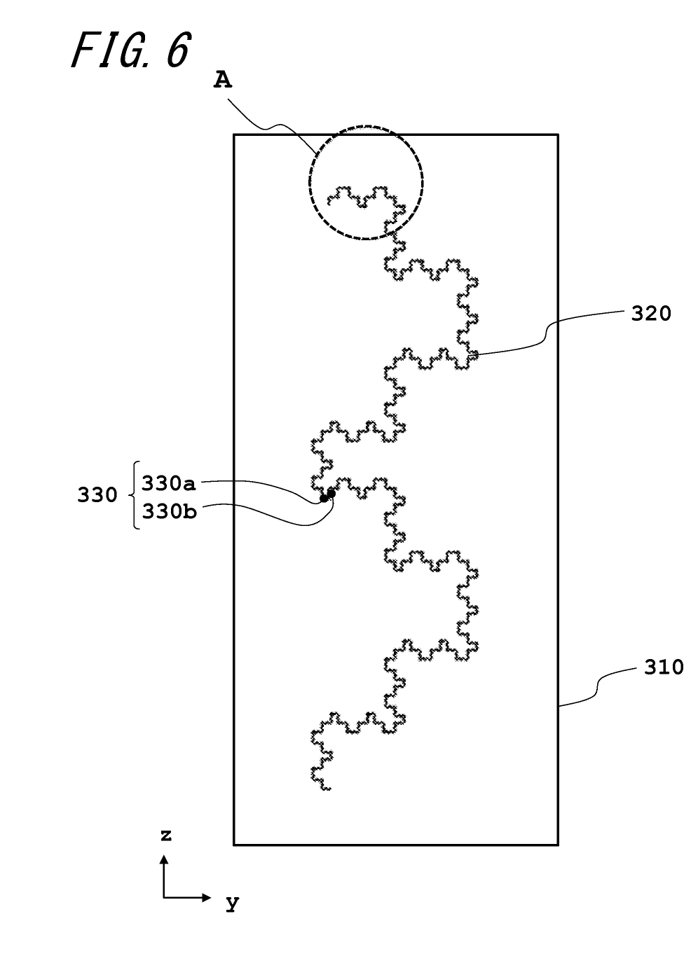

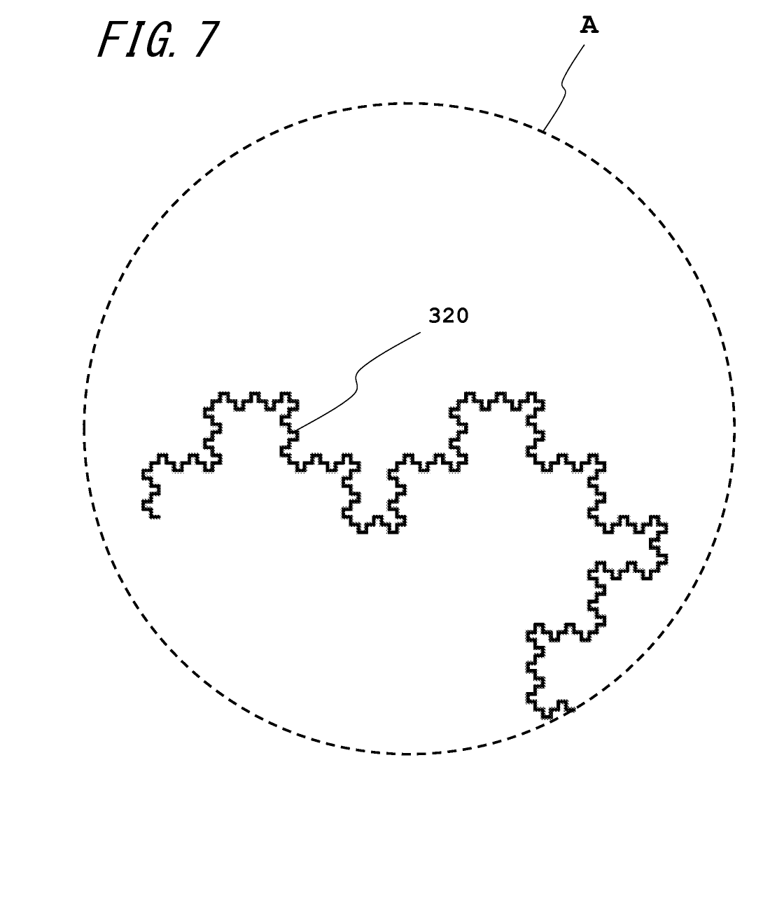

FIG. 6 is a top view schematically illustrating an antenna according to a fourth embodiment of the invention. In addition, FIG. 7 is an enlarged view illustrating a conductor state of the region A of FIG. 6. In addition, in this embodiment, a difference from the above-described embodiments will be described, and repeated description of the same element will be omitted. When this embodiment is generally expressed, the maximum order m is 6, and the division number p is 4.

As shown in FIGS. 6 and 7, a conductor 320 of the antenna of this embodiment is provided on a dielectric substrate 310 and is formed by sequentially connecting 1024 sixth order elements having a strip-shape. The sixth order elements have a shape in which each of the fifth order elements of the conductor 220 of the antenna shown in FIG. 5 is divided into four sixth order elements having the same length, and boundary parts of the sixth order elements in each of the fifth order elements are sequentially bent in a reverse direction such that a vector direction from one end of each of the fifth order elements to the other end thereof does not vary and an angle between the sixth order elements adjacent to each other is 90°.

According to the antenna of this embodiment, it is possible to obtain a miniaturized antenna which maintains approximately the same antenna characteristics including directivity and has a length in the longitudinal direction (z direction in the figure) reduced to a length multiplied by 2 5/2 as compared with a basic antenna having a linear conductor such as the first order element 41 of FIG. 3.

In addition, as shown in FIG. 6, the conductor 320 of the antenna may be equally divided into two at the center in the longitudinal direction, and may function as a dipole antenna by providing power supply points 330a and 330b at the division part 330. A line segment connecting both ends of a first antenna (on which the power supply point 330a is located) and a line segment connecting both ends of a second antenna (on which the power supply point 330b is located) are located on the same straight line, which thus can be regarded as the dipole antenna according to an embodiment of the invention.

### Modified Example 1

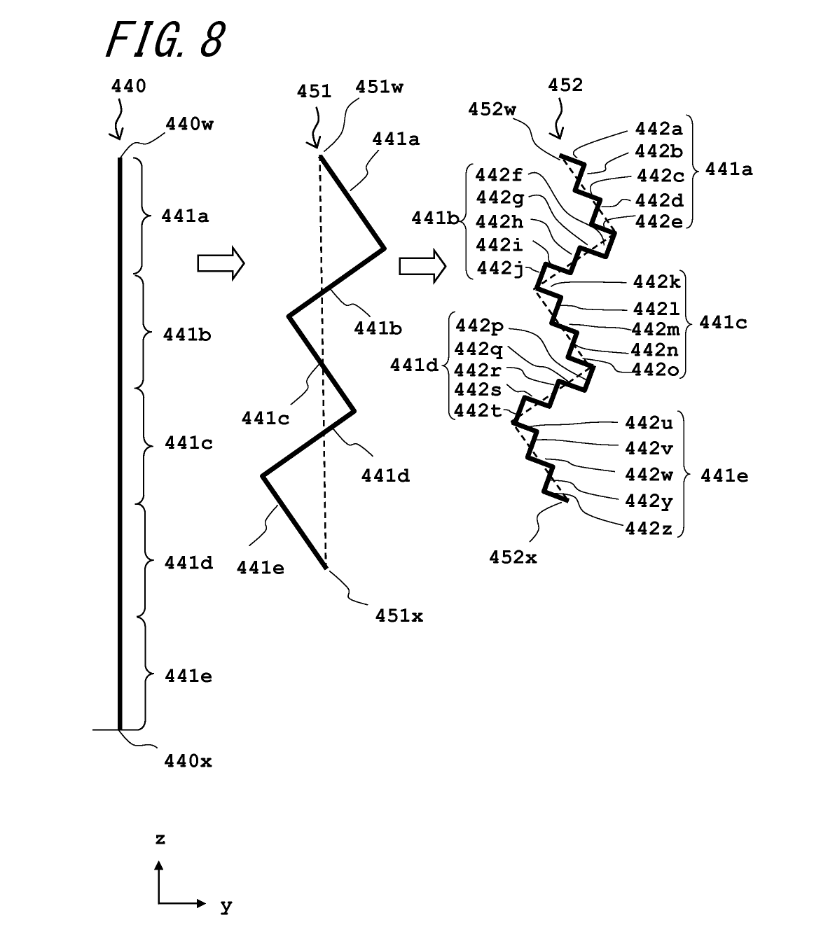

Although a description has been made that the division number p is 4, and an angle between the n-th order elements adjacent to each other is 90° in the embodiments, the invention is not limited thereto. FIG. 8 is a schematic plan view illustrating a modified example of the shape of the conductor. In addition, in this embodiment, a difference from the first embodiment described with reference to FIG. 3 will be described, and repeated description of the same element will be omitted. When this embodiment is generally expressed, the maximum order m is 3, and the division number p is 5. In addition, an angle of the n-th order elements adjacent to each other is 90°.

A first order element 440 is divided into five second order elements 441a to 441e. In addition, since each of the five second order elements is divided into five third order elements, there are twenty-five third order elements 442a to 442z in total. As a result, the conductor in the antenna of this embodiment has a structure formed by sequentially connecting the twenty-five strip-shaped third order elements 442a to 442z.

The linear first order element 440 is divided into the five second order elements 441a to 441e. In addition, respective boundary parts of the second order elements 441a to 441e have a bent shape along a straight line (indicated by the dotted line; 451w to 451x) parallel to a line segment which connects one end 440w of the first order element 440 to the other end 440x thereof. In other words, the boundary parts of the respective second order elements 441a to 441e have a folded shape such that a vector direction from one end of the first order element 440 to the other end thereof does not vary.

In addition, each of the five second order elements 441a to 441e is divided into five third order elements. At this time, respective boundary parts of the third order elements 442a to 442e have a bent shape along a straight line (indicated by the dotted line) parallel to a line segment which connects one end of the second order element 441a to the other end thereof. In the same manner for the other four second order elements 441b to 441e, boundary parts of the respectively corresponding third order elements have a bent shape. In other words, the boundary parts of the respective third order elements 442a to 442z have a folded shape such that a vector direction from one end of each of the second order elements 441a to 441e to the other end thereof does not vary.

### Modified Example 2

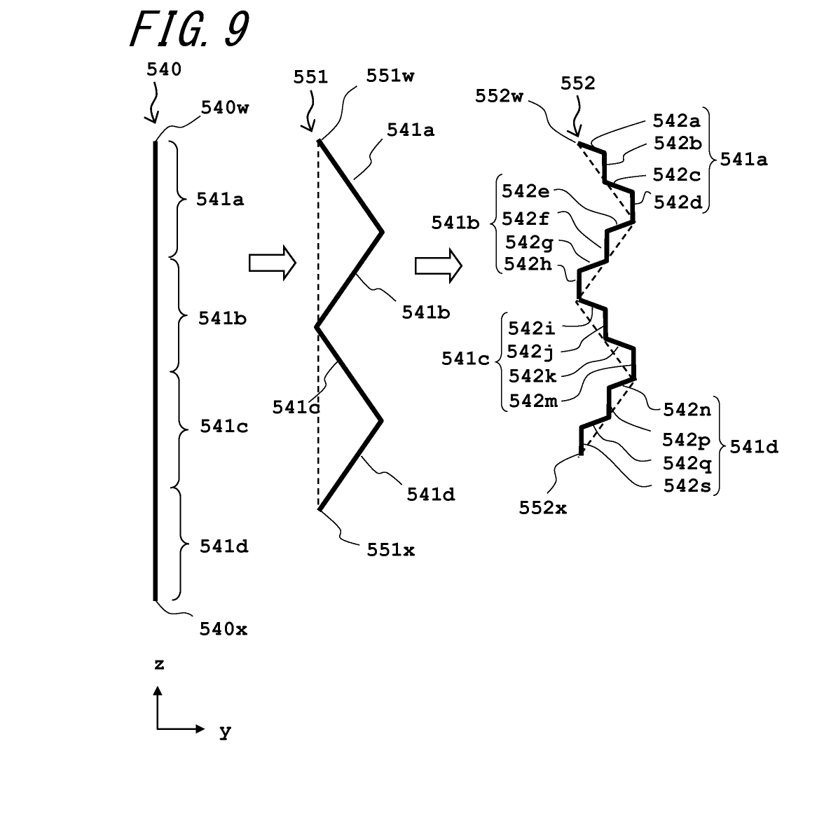

FIG. 9 is a schematic plan view illustrating a modified example of the shape of the conductor. In addition, in this embodiment, a difference from the first embodiment described with reference to FIG. 3 will be described, and repeated description of the same element will be omitted. When this embodiment is generally expressed, the maximum order m is 3, and the division number p is 4, which is the same as in the first embodiment, but an angle between the n-th order elements adjacent to each other is greater than 90°, which is different from in the first embodiment.

A first order element 540 is divided into four second order elements 541a to 541d. In addition, each of the four second order elements is divided into four third order elements, and thus there are a total of sixteen third order elements 542a to 542s. As a result, the conductor in the antenna of this embodiment has a structure formed by sequentially connecting the sixteen strip-shaped third order elements 542a to 542s.

Here, an angle formed between the second order elements 541a to 541d adjacent to each other is greater than 90°. In addition, an angle formed between the third order elements 542a to 542s adjacent to each other is also greater than 90°.

As mentioned above, both the antennas of the modified examples 1 and 2 shown in FIGS. 8 and 9 have a length which is reduced in the longitudinal direction (z direction in the figure) as compared with an antenna having a linear conductor shown in each first order element. In addition, since the above-described operations and effects of an antenna of the invention are achieved, it is possible to obtain an antenna which maintains approximately the same antenna characteristics and is miniaturized as compared with a linear antenna having the same length.

### Modified Example 3

Next, a modified example of the dipole antenna will be described. In the above-described first to fourth embodiments, a central part of a conductor is divided and is provided with power supply points so as to form a first antenna and a second antenna having the same shape, and thereby a line segment connecting both ends of the first antenna and a line segment connecting both ends of the second antenna are made to be located on the same straight line so as to form a dipole antenna; however, the invention is not limited thereto.

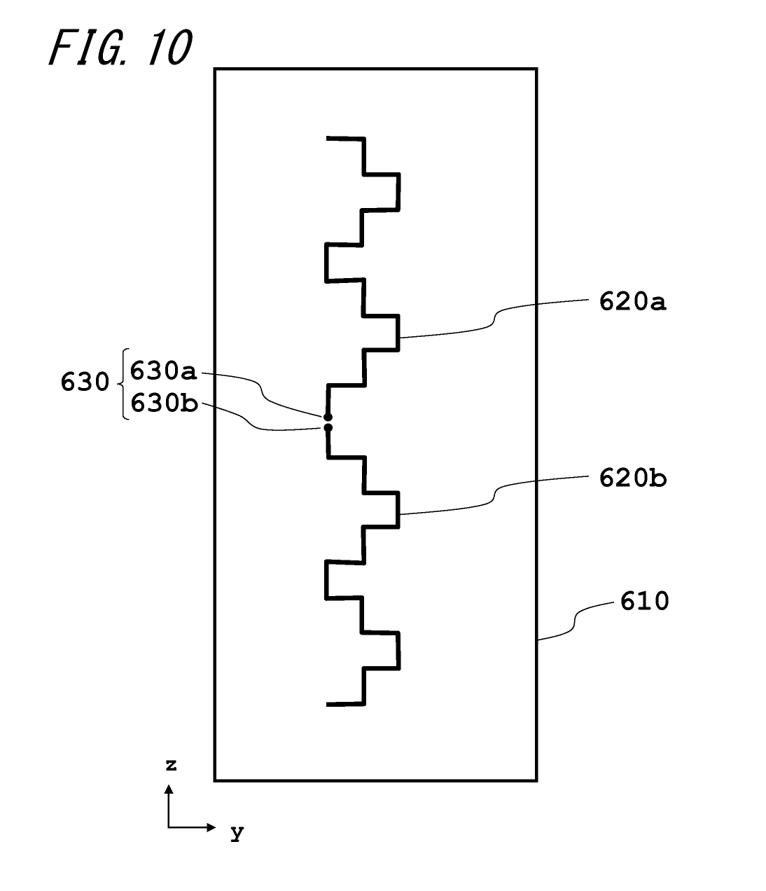

FIG. 10 shows a modified example of the dipole antenna of the invention. A conductor 620a of the first antenna and a conductor 620b of the second antenna have shapes which are line-symmetric to each other with respect to a straight line passing through the power supply point 630 of the dipole antenna, which is an axis of symmetry. In addition, the first order element of each conductor is linear, and two line segments connecting both ends of the respective conductors are located on the same straight line. In addition, the axis of symmetry of line symmetry is perpendicular to the straight line.

According to the dipole antenna having this configuration, in the two conductors 620 (620a and 620b), magnitudes of currents flowing through the m-th order elements located at an equal distance from the power supply point are the same, and a component in a direction perpendicular to the line segment connecting both ends of the conductors 620 is in a reverse direction. Therefore, current components in the direction perpendicular to the line segment connecting both ends of the conductors 620 (620a and 620b) cancel out each other between the two conductors 620a and 620b, and thus a direction of a vector sum of currents flowing through the respective parts of the two conductors 620a and 620b conforms to a direction of a vector from the one end of the conductors 620 (620a and 620b) to the other end thereof. Therefore, according to the dipole antenna having this configuration, it is possible to obtain a dipole antenna which maintains approximately the same characteristics also including directivity and is miniaturized, as compared with a dipole antenna which has a linear conductor.

### Modified Example 4

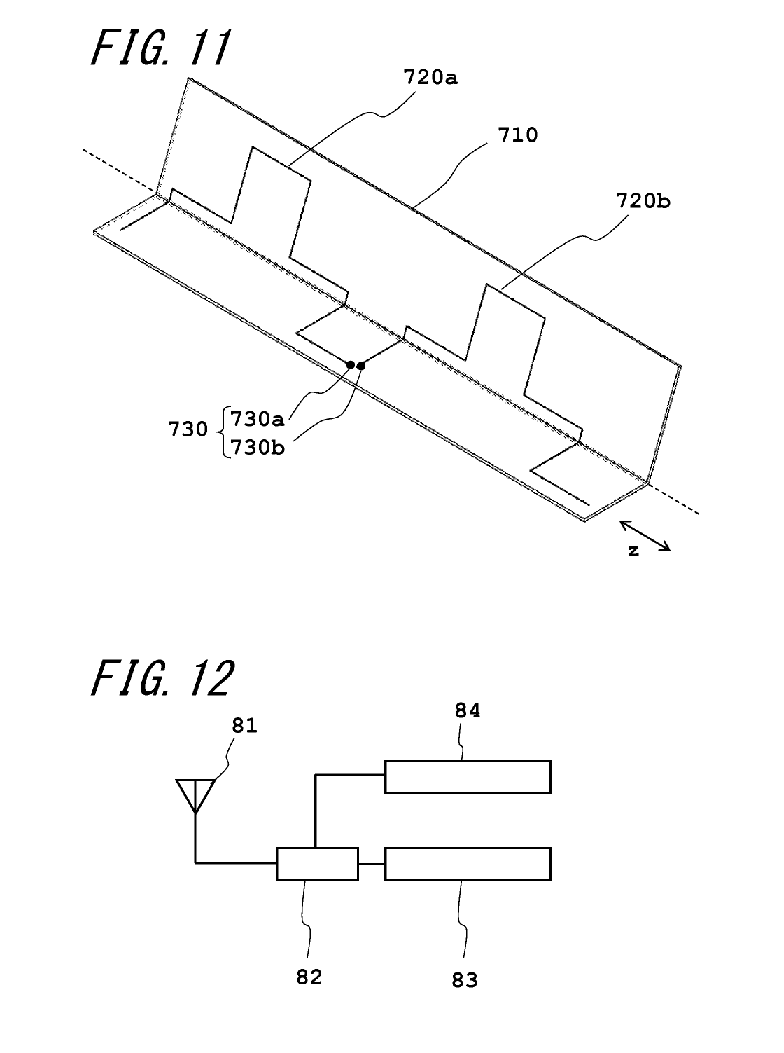

FIG. 11 is a perspective view schematically illustrating a modified example of the antenna of the invention. The antenna of this embodiment, as shown in FIG. 11, has a configuration in which a conductor 720 and a dielectric substrate 710 are folded with respect to an axis, which is a straight line parallel to a straight line connecting one end of the conductor 720 to the other end thereof in the antenna of the first embodiment shown in FIGS. 1 and 2. This axis is an axis parallel to the z axis shown in each figure.

According to the antenna with this configuration, a size in the width direction can be reduced in addition to the longitudinal direction, and thus it is possible to obtain a further miniaturized antenna. In addition, since the conductor 720 is folded with respect to the axis, which is the straight line parallel to the straight line connecting one end of the conductor 720 to the other end thereof, a state is preserved in which components of currents flowing through the respective parts of the conductor 720, perpendicular to the straight line connecting the one end of the conductor 720 to the other end thereof, cancel out each other. Therefore, antenna characteristics including directivity are almost not changed as compared with the conductor before being folded. In other words, according to this embodiment, it is possible to obtain an antenna which has dimensions reduced in both the longitudinal direction and the width direction, is miniaturized, has a high performance, and is easily designed, almost without changing the antenna characteristics including directivity.

This is exactly the same for a case of the dipole antenna, and folding can be performed with respect to an axis, which is a straight line parallel to a straight line on which a line segment connecting both ends of each of the conductor 720a of the first antenna and the conductor 720b of the second antenna is located.

In addition, FIG. 11 shows an example in which the conductor 720 is folded only once at a predetermined angle with respect to the axis, which is the straight line parallel to the straight line connecting one end of the conductor to the other end thereof; however, the invention is not limited thereto. A folded angle may be small or large, and folding may be performed multiple times. In addition, the conductor may be folded smoothly, in a cylindrical shape, or in a spiral shape. In addition, there may be any number of axes when the conductor is folded. Particularly, by providing the antenna (dipole antenna) of the invention on a flexible substrate made of a material such as polyimide, the conductor can be freely folded with respect to the above-described predetermined axis (for example, a straight line parallel to a straight line connecting one end of the conductor to the other end thereof), and thus it is possible to easily accommodate the miniaturized antenna in a small communication apparatus such as a mobile phone which is a communication apparatus having a limitation of an internal volume.

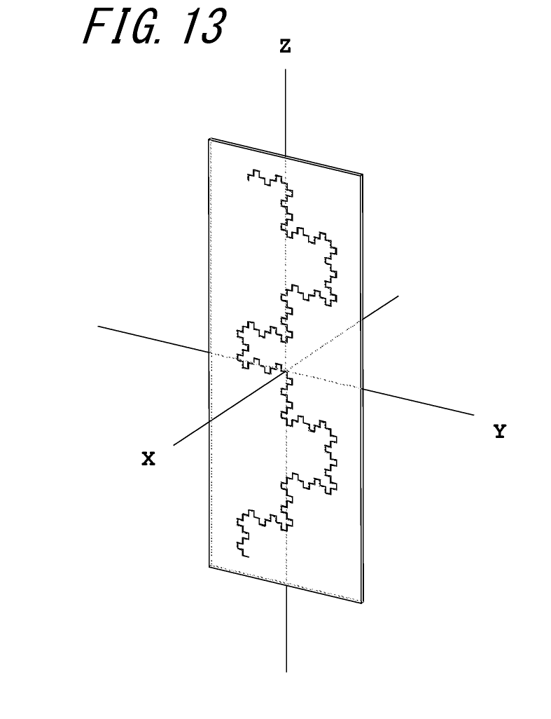

Next, FIG. 12 is a block diagram schematically illustrating a communication apparatus according to an embodiment of the invention. The communication apparatus of this embodiment includes an antenna 81 of the invention, and a receiving circuit 83 and a transmitting circuit 84 which are connected to the antenna 81 via an antenna sharing machine 82. The antenna or the dipole antenna of any of the above-described embodiments may be employed as the antenna 81 of the invention.

According to the communication apparatus of this embodiment with this configuration, transmitting and receiving of a communication signal are performed using the antenna 81 of the invention which is miniaturized and has good electrical characteristics, and thus it is possible to obtain a communication apparatus which is miniaturized and good electrical characteristics.

The invention is not limited to the above-described embodiments, and may be variously modified or changed without departing from the scope of the invention. In addition, the examples shown in the respective embodiments and the modified examples may be combined.

For example, in the above-described embodiments, the examples in which the dipole antenna is configured have been described; however, the invention is not limited thereto. For example, a monopole antenna may be configured by supplying power to one end of a conductor. In addition, in the above-described embodiments, the examples in which a maximum of 1024 sixth order elements having a strip-shaped is configured have been described; however, the invention is not limited thereto. It is possible to obtain an antenna which is further miniaturized by further increasing the order of elements.

In addition, in the above-described embodiments, the examples in which the (n−1)-th order element is equally divided into four or five have been described; however, the (n−1)-th order element may be equally divided into three or more, or may not be equally divided. Further, in the above-described embodiments, the examples in which the boundary parts of the n-th order elements adjacent to each other are sequentially folded in a reverse direction have been described; however, the invention is not limited thereto, and the boundary parts of the n-th order elements adjacent to each other may not be sequentially folded in a reverse direction. In addition, although the example in which an angle at which a pattern is folded is 90° or more has been described, an angle may be smaller than this angle, and the pattern may be bent smoothly.

### EXAMPLES

Next, Examples of the invention will be described.

First, a radiation characteristic of the antenna of the third embodiment (the maximum order m=5, and the division number p=4) shown in FIG. 5 was calculated through a simulation. In addition, as Comparative Example, a radiation characteristic of a linear dipole antenna having the linear conductor 20 such as the first order element 41 of FIG. 3 was simulated together. In these simulations, the dielectric constant of the dielectric substrate 10 was set to 1, the width of the conductor 20 was set to 0.2 mm, the overall length of the conductor 20 was set to 750 mm, and the central frequency thereof was set to 200 MHz.

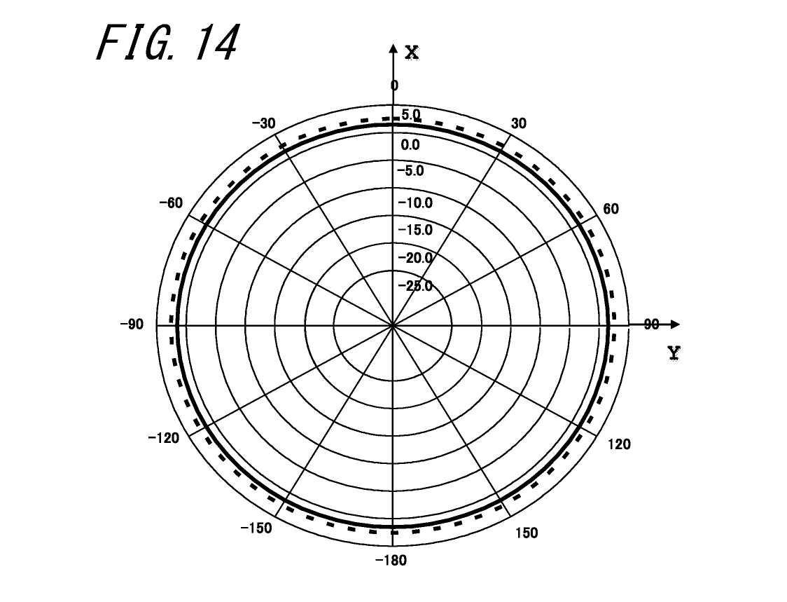

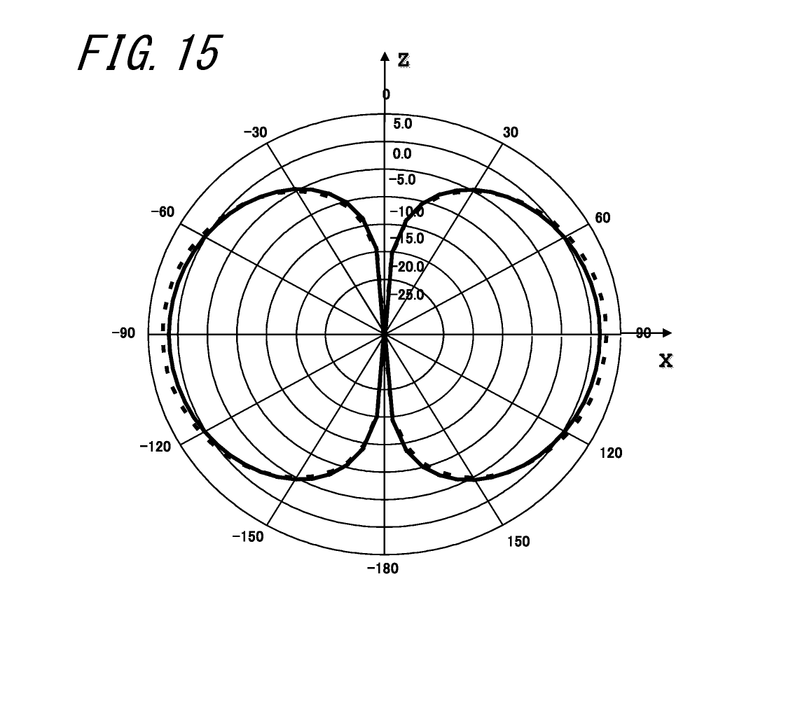

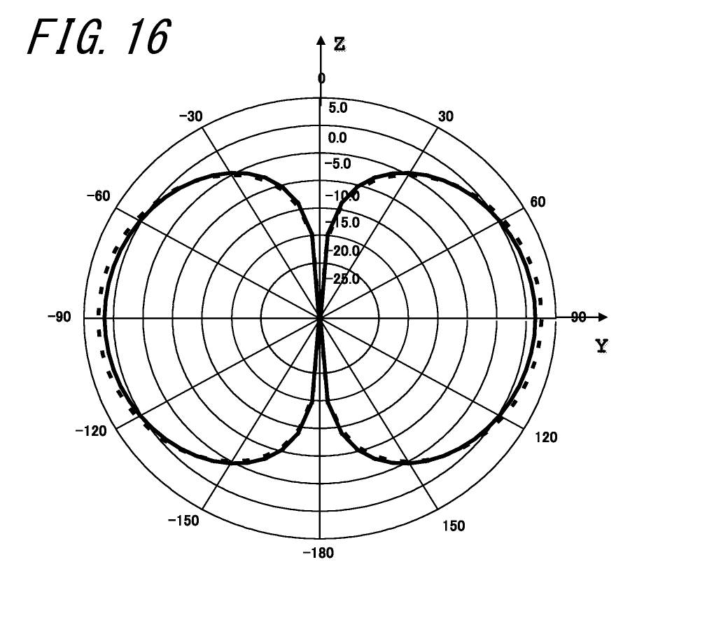

A coordinate system in these simulations is shown in FIG. 13, and simulation results are shown in FIGS. 14 to 16. FIG. 14 shows a radiation pattern of a directional gain on an xy plane, FIG. 15 shows a radiation pattern of a directional gain on a zx plane, and FIG. 16 shows a radiation pattern of a directional gain on a zy plane. In addition, in FIGS. 9 to 11, the radiation pattern of the directional gain of the antenna of Example is indicated by the solid line, and the radiation pattern of the directional gain of the antenna of Comparative Example is indicated by the broken line.

In the graphs shown in FIGS. 14 to 16, the solid line and the broken line draw approximately the same trajectory, and thus it can be seen that the antenna of Example has a ¼ length in the longitudinal direction (z direction in the figure) as compared with the antenna of Comparative Example but has approximately the same characteristics also including directivity as compared with the antenna of Comparative Example.

Next, a radiation characteristic of the antenna of the second embodiment (the maximum order m=4, and the division number p=4) shown in FIG. 4, and an antenna in which the antenna of the second embodiment shown in FIG. 4 is folded at 90° with respect to an axis parallel to the z axis as in FIG. 11, was calculated through simulations. In these simulations, the dielectric constant of the dielectric substrate 10 was set to 1, the width of the conductor 20 was set to 0.2 mm, the overall length of the conductor 20 was set to 750 mm, and the central frequency thereof was set to 270 MHz. In addition, a coordinate system in these simulations was the same as in FIG. 13.

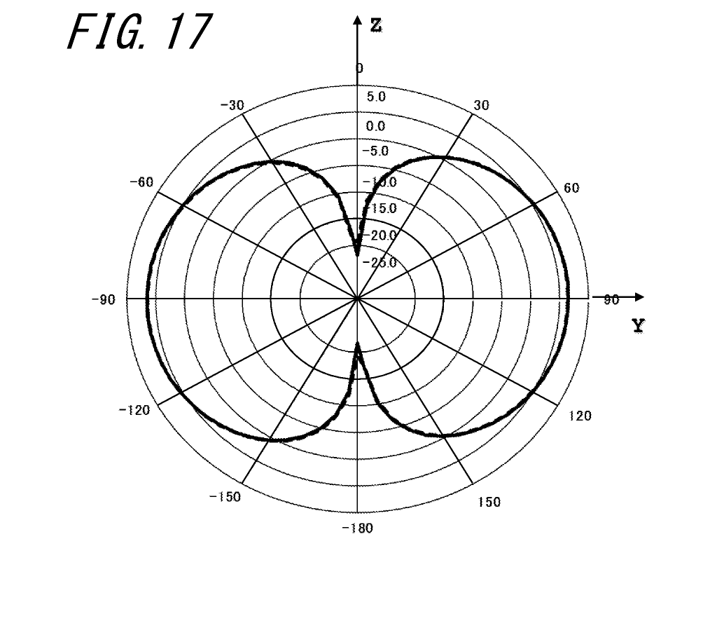

A simulation result thereof is shown in FIG. 17. FIG. 17 shows a radiation pattern of a directional gain on the zy plane. The radiation pattern of the directional gain of the antenna which is folded at 90° is indicated by the solid line, and the radiation pattern of the directional gain of the antenna which is shown in FIG. 4 and is not folded is indicated by the broken line. It can be seen from the graph shown in FIG. 17 that the solid line and the broken line draw the same line in an overlapping manner, and radiation characteristics also including directivity almost do not vary before and after folding.

As described above, the advantages of the invention can be confirmed from the simulation results shown in FIGS. 14 to 17.

### REFERENCE SIGNS LIST

10: Dielectric substrate
20: Conductor
41: First order element
42a to 42d: Second order element
43a to 43s: Third order element
81: Antenna
83: Receiving circuit
84: Transmitting circuit

1. An antenna, comprising:
a strip-shaped conductor in which a plurality of strip-shaped m-th order elements, where m is an integer of 3 or more, are sequentially connected to one another,
wherein
n-th order elements constituting the strip-shaped conductor, where n is all integers equal to or more than 2 and equal to or less than m, are configured to be p n-th order elements into which an (n−1)-th order element is divided, where p is an integer of 3 or more, and
the n-th order elements divided into p have bent shapes at respective boundary parts between the n-th order elements and are located along a straight line parallel to a line segment connecting one end of the (n−1)-th order element to the other end thereof.

2. The antenna according to claim 1, wherein the n-th order elements divided into p all have same length, and angles formed between the n-th order elements adjacent to each other in each of the (n−1)-th order elements are all the same.

3. A dipole antenna, comprising:
a plurality of the antennas according to claim 1, wherein
the plurality of the antennas comprise a first antenna and a second antenna, and
a shape of the strip-shaped conductor of the first antenna and a shape of the strip-shaped conductor of the second antenna are line-symmetric, each of first order elements of the strip-shaped conductors being linear, and line segments connecting both ends of each of the strip-shaped conductors are located on a same straight line.

4. A dipole antenna, comprising:
a plurality of the antennas according to claim 1, wherein
the plurality of the antennas comprise a first antenna and a second antenna, and
a shape of the strip-shaped conductor of the first antenna and a shape of the strip-shaped conductor of the second antenna are the same, and line segments connecting both ends of each of the strip-shaped conductors are located on a same straight line.

5. The antenna according to claim 1, wherein the strip-shaped conductor has a structure of being bent with respect to an axis, which is a straight line parallel to a straight line connecting one end and the other end of the strip-shaped conductor.

6. The dipole antenna according to claim 3, wherein the strip-shaped conductors forming the first antenna and the second antenna have a structure of being bent with respect to an axis, which is a straight line parallel to a straight line on which line segments connecting both ends of each of the strip-shaped conductors of the first antenna and the second antenna are located.

7. A communication apparatus, comprising:
the antenna according to claim 1; and
at least one of a receiving circuit and a transmitting circuit which are connected to the antenna.

8. A communication apparatus, comprising:
the dipole antenna according to claim 3; and
at least one of a receiving circuit and a transmitting circuit which are connected to the dipole antenna.

9. A dipole antenna, comprising:
a plurality of the antennas according to claim 2, wherein
the plurality of the antennas comprise a first antenna and a second antenna, and
a shape of the strip-shaped conductor of the first antenna and a shape of the strip-shaped conductor of the second antenna are line-symmetric, each of first order elements of the strip-shaped conductors being linear, and line segments connecting both ends of each of the strip-shaped conductors are located on a same straight line.

10. A dipole antenna, comprising:
a plurality of the antennas according to claim 2, wherein
the plurality of the antennas comprise a first antenna and a second antenna, and
a shape of the strip-shaped conductor of the first antenna and a shape of the strip-shaped conductor of the second antenna are the same, and line segments connecting both ends of each of the strip-shaped conductors are located on a same straight line.

11. The antenna according to claim 2, wherein the strip-shaped conductor has a structure of being bent with respect to an axis, which is a straight line parallel to a straight line connecting one end and the other end of the strip-shaped conductor.

12. The dipole antenna according to claim 4, wherein the strip-shaped conductors forming the first antenna and the second antenna have a structure of being bent with respect to an axis, which is a straight line parallel to a straight line on which line segments connecting both ends of each of the strip-shaped conductors of the first antenna and the second antenna are located.

13. A communication apparatus, comprising:
the antenna according to claim 2; and
at least one of a receiving circuit and a transmitting circuit which are connected to the antenna.

14. A communication apparatus, comprising:
the antenna according to claim 5; and
at least one of a receiving circuit and a transmitting circuit which are connected to the antenna.

15. A communication apparatus, comprising:
the dipole antenna according to claim 4; and
at least one of a receiving circuit and a transmitting circuit which are connected to the dipole antenna.

16. The dipole antenna according to claim 9, wherein the strip-shaped conductors forming the first antenna and the second antenna have a structure of being bent with respect to an axis, which is a straight line parallel to a straight line on which line segments connecting both ends of each of the strip-shaped conductors of the first antenna and the second antenna are located.

17. The dipole antenna according to claim 10, wherein the strip-shaped conductors forming the first antenna and the second antenna have a structure of being bent with respect to an axis, which is a straight line parallel to a straight line on which line segments connecting both ends of each of the strip-shaped conductors of the first antenna and the second antenna are located.

18. A communication apparatus, comprising:
the antenna according to claim 11; and
at least one of a receiving circuit and a transmitting circuit which are connected to the antenna.

19. A communication apparatus, comprising:
the dipole antenna according to claim 9; and
at least one of a receiving circuit and a transmitting circuit which are connected to the dipole antenna.

20. A communication apparatus, comprising:
the dipole antenna according to claim 10; and
at least one of a receiving circuit and a transmitting circuit which are connected to the dipole antenna.
